(19) United States
(12) Patent Application Publication
(10) Pub. No.: US 2015/0183337 A1
(43) Pub. Date: Jul. 2, 2015

(54) TEMPERATURE MANAGEMENT SYSTEM OF FUEL CELL VEHICLE AND METHOD THEREOF

(71) Applicants: Hyundai Motor Company, Seoul (KR); Kia Motors Corporation, Seoul (KR)

(72) Inventors: Sung Wook Na, Yongin (KR); Hun Woo Park, Namyangju (KR)

(21) Appl. No.: 14/474,673

(22) Filed: Sep. 2, 2014

(30) Foreign Application Priority Data
Dec. 30, 2013 (KR) 10-2013-0166675

(51) Int. Cl. B60L 11/18

(52) U.S. Cl. CPC B60L 11/1892

(57) ABSTRACT

A temperature management system of a fuel cell vehicle includes a radiator, a water pump, an ion filter, a flow control valve, a state detector and a controller. The radiator is configured to emit heat generated from a fuel cell stack via cooling water, and the water pump is configured to circulate the cooling water through the system. Additionally, an ion filter is disposed in a branch line branched from a cooling water circulating line connecting the fuel cell stack and the radiator. The state detector is configured to detect cooling water state information and the flow control valve is configured to selectively interrupt a flow of the cooling water into the ion filter; and a controller configured to control an operation of the flow control valve depending on the cooling water state information detected by the state detector.

### CROSS-REFERENCE TO RELATED APPLICATION

This application claims under 35 U.S.C. §119(a) the benefit of Korean Patent Application No. 10-2013-0166675 filed on Dec. 30, 2013, the entire contents of which are incorporated herein by reference.

### BACKGROUND

(a) Technical Field

The present disclosure relates to a temperature management system of a fuel cell vehicle and a method thereof. More particularly, the present disclosure relates to a temperature management system of a fuel cell vehicle and a method thereof that reduces of the number of times a high temperature current limiting mode is entered by increasing a flow rate of cooling water and a heat radiating amount in a radiator accordingly.

(b) Background Art

A fuel cell system constructed in a fuel cell vehicle includes 1) a fuel cell stack which generates electric energy from an electrochemical reaction from reaction gas, 2) a hydrogen supply apparatus which supplies hydrogen, i.e., fuel, to the fuel cell stack, 3) an air supply apparatus which supplies air including oxygen to the fuel cell stack, and 4) a temperature and water management system which dissipates the heat generated by the fuel cell stack to the outside to optimally control an operating temperature and manage water production.

Typically, a fuel cell stack emits heat and water as reaction byproducts during an electrochemical reaction process of, for example, hydrogen and oxygen (i.e., typical reaction gases). However, in order for the fuel cell stack to exhibit an optimal output performance, a temperature of the fuel cell stack needs to be managed at an optimum temperature during ignition and operation.

Therefore, it is essential to use a temperature management system which rapidly increases the temperature of the fuel cell stack during ignition while still maintaining the temperature of the fuel cell stack at the optimum temperature during operation.

A conventional temperature management system of the fuel cell vehicle is illustrated in FIG. 1. FIG. 1 is a schematic diagram illustrating a cooling water loop in a temperature management system of a fuel cell vehicle, in which the temperature management system of the fuel cell vehicle includes a radiator 2 which emits heat generated when the fuel cell stack 1 generates power to the outside, a cooling water circulating line 3 which is connected between the fuel cell stack 1 and the radiator 2 to be able to circulate cooling water therebetween, a bypass line 4 and a 3-way valve 5 which selectively bypass the cooling water to prevent the cooling water from passing through the radiator 2, a water pump 6 which pumps and circulates the cooling water, and a heater 7 which increases the temperature of the cooling water to warm up the fuel cell stack. Further, to maintain electric conductivity of the cooling water at a predetermined level or less, a de-mineralizer (DMN) 9 which filters ions present in the cooling water is equipped in a branch line 8 of the cooling water loop.

The temperature management system in FIG. 1 emits the heat generated during the fuel cell stack operation to the outside while circulating the cooling water along a path of radiator 2 to the 3-way valve 5 then to the water pump 6 followed by the heater 7 and final back into the fuel cell stack 1.

Since a polymer electrolyte fuel cell (PEFMC) (which are often the type of fuel cell that is used in fuel vehicles) is operated at low temperatures, a radiator having a large heat radiating area is required to maintain the fuel at those low temperatures, but during warmer weather, the amount of heat that is dissipated by the radiator is less than the amount of heat generated by the fuel cell stack and as such the radiator is not often sufficient to cool the fuel cell under these conditions.

Therefore, as illustrated in FIG. 2, when the temperature of the cooling water at an outlet of the fuel cell stack is increased and thus reaches a set temperature, a fuel cell controller (FCU) limits a current output from the fuel cell stack to protect the fuel cell stack and to prevent the temperature of the cooling water from increasing higher than the set temperature, which is called a high temperature current limitation.

When the rapid acceleration and high output operation of the vehicle is continued (for example, driving on a highway or driving uphill) or the flow rate of the cooling water is insufficient during warmer weather, the cooling water is increased to a high temperature and thus this high temperature current limitation frequently occurs. Therefore, the output from the fuel cell stack is insufficient when a driver presses an accelerator pedal during this current limitation period.

Since there is a need to increase the insufficient heat radiating ability in order to prevent the high temperature current limitation from frequently occurring, a method for additionally increasing heat radiating areas of a radiator needs to be considered but has many limitations due to a vehicle layouts.

Further, the heat radiating performance should be maximized using the high performance/high flow rate pump, but when the pressure while pumping of the cooling water exceeds an internal pressure level of the fuel cell stack during high output of the pump, leaks in the fuel cell stack may occur due to the structure of the fuel cell stack from this increased pressure.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present disclosure has been made in an effort to solve the above-described problems associated with related art, and provides a temperature management system of a fuel cell vehicle and a method thereof capable of reducing of the number of time (frequency) a high temperature current limiting mode is entered by increasing a flow rate of cooling water and a heat radiating amount in a radiator.

Further, the present disclosure has also been made in an effort to provide a temperature management system of a fuel cell vehicle and a method thereof that reduces a current limiting time delay of arrival and a limiting time and contributes to improvement in performance and quality of a vehicle while improving a heat radiating performance of a fuel cell vehicle.

In one aspect, the present disclosure provides a temperature management system of a fuel cell vehicle, including: a radiator configured to emit heat generated from a fuel cell stack to the outside through cooling water; a water pump configured to circulate the cooling water; an ion filter disposed in a branch line branched from a cooling water circulating line connecting the fuel cell stack and the radiator to pass the cooling water therethrough; a state detector (e.g., sensor) configured to detect cooling water state information; a flow control valve configured to selectively interrupt a flow of the cooling water into the ion filter; and a controller configured to control an operation of the flow control valve depending on the cooling water state information detected by the state detector.

In another aspect, the present disclosure provides a temperature management method of a fuel cell vehicle, including: detecting, by a state detector, cooling water state information while the cooling water being circulated along a cooling water circulating line between a fuel cell stack and a radiator by a water pump; and controlling, by a controller, an operation of a flow control valve depending on the cooling water state information detected by the state detector, wherein the flow control valve is equipped to selectively interrupt a flow of the cooling water into an ion filter.

Therefore, according to the temperature management system and method according to the present disclosure, the ion filter is selectively used depending on electric conductivity of the cooling water or the temperature of the cooling water and therefore the durability of the ion filter may be improved and the lifespan thereof may be expanded.

Further, the flow rate of the cooling water and the heat radiating amount (i.e., heat transfer rate) in the radiator may be increased by interrupting the cooling water path using the ion filter, and therefore the number of times that the vehicle enters the high temperature current limiting mode may be reduced.

In addition, the heat radiating performance of the fuel cell vehicle may be improved by controlling the cooling water of the ion filter path, and therefore the current limiting time delay of arrival and the limiting time may be reduced, thereby contributing to the improvement in the performance and quality of the vehicle.

Moreover, the flow rate of the cooling water flowing in the radiator may be increased under the condition in which electric conductivity is not high, and therefore the driving loss of the water pump may be reduced, thereby contributing to the improvement in fuel efficiency of the fuel cell vehicle.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a schematic diagram illustrating a cooling water loop in a temperature management system of a fuel cell vehicle;

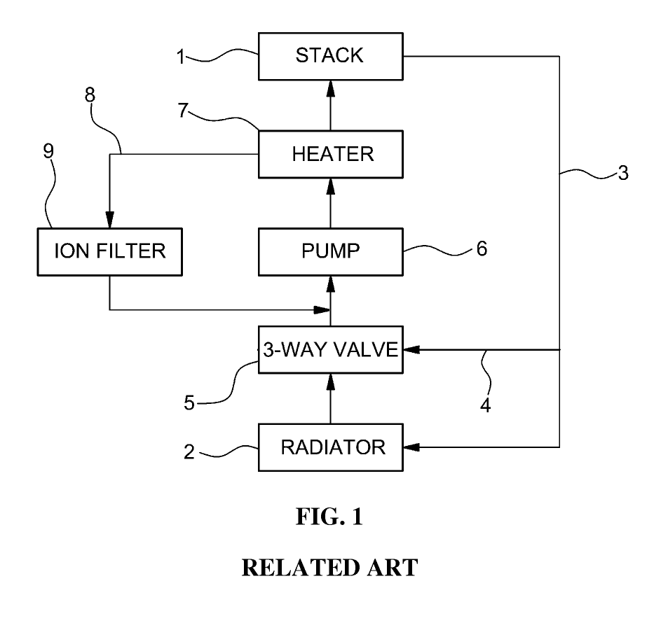

FIG. 2 is a diagram illustrating a current limiting process of a fuel cell system;

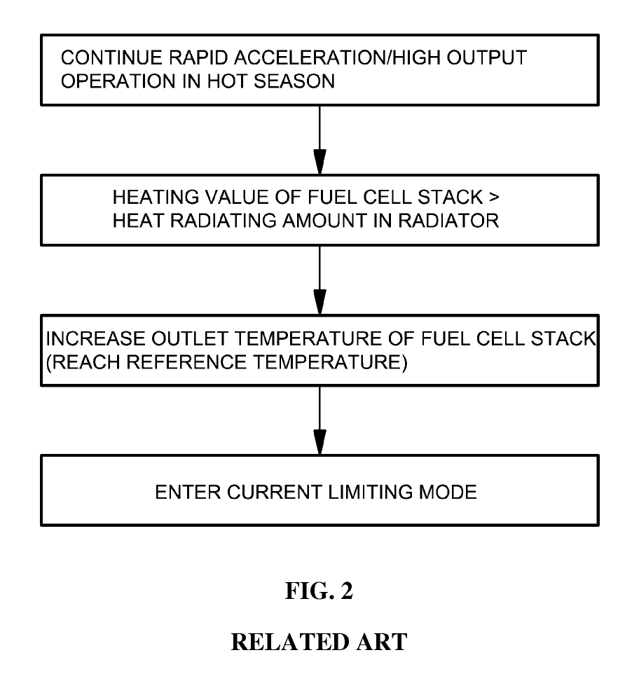

FIG. 3 is a schematic diagram illustrating a temperature management system according to an exemplary embodiment of the present disclosure; and

FIG. 4 is a block diagram illustrating a configuration of a system for controlling a valve in the temperature management system according to the exemplary embodiment of the present disclosure.

Reference numerals set forth in the Drawings includes reference to the following elements as further discussed below:

| | |
|---|---|
| 1: fuel stack | 2: radiator |
| 3: cooling water circulating line | 4: bypass line |
| 5: 3-way valve | 6: water pump |
| 7: heater | 8: branch line |
| 9: ion filter | 11: electric conductivity sensor |
| 12: temperature sensor | 20: fuel cell control unit (controller) |
| 31: flow control valve | |

It should be understood that the appended drawings are not necessarily to scale, presenting a somewhat simplified representation of various exemplary features illustrative of the basic principles of the invention. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter reference will now be made in detail to various embodiments of the present disclosure, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Additionally, it is understood that the below methods are executed by at least one controller. The term controller refers to a hardware device that includes a memory and a processor configured to execute one or more steps that should be interpreted as its algorithmic structure. The memory is configured to store algorithmic steps and the processor is specifically configured to execute said algorithmic steps to perform one or more processes which are described further below. Further, the controller may be configured to interpolate data received from the state detectors to be used in control logic accordingly.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Hereinafter, exemplary embodiments of the present disclosure will be described in detail with reference to the accompanying drawings so as to be easily practiced by a person skilled in the art to which the present disclosure pertains.

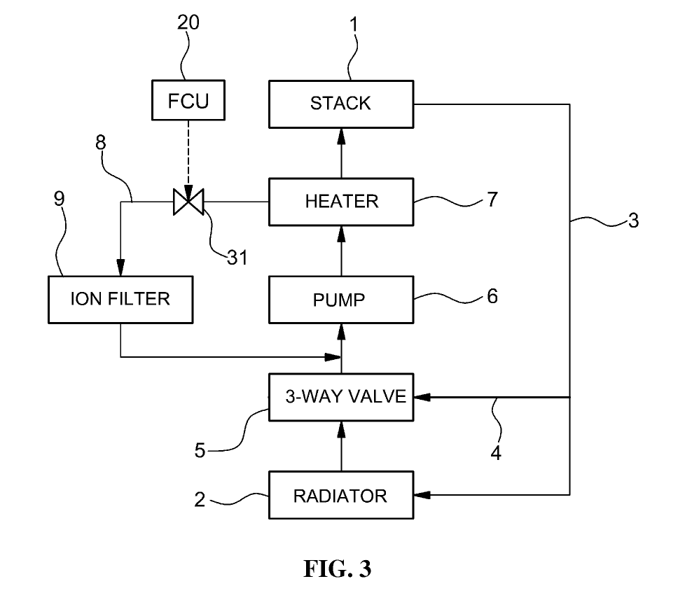

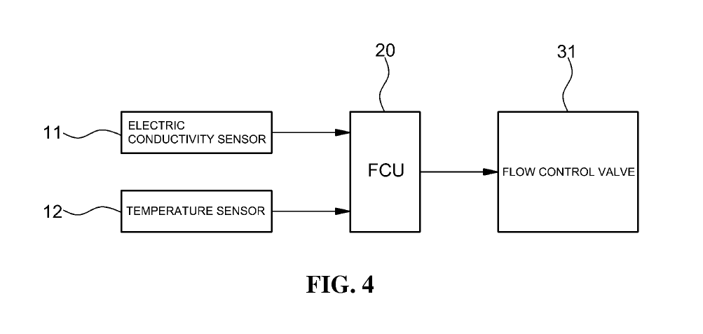

FIG. 3 is a schematic diagram illustrating a temperature management system according to an exemplary embodiment of the present disclosure and is a diagram illustrating a configuration of a cooling water loop of a fuel cell vehicle and FIG. 4 is a block diagram illustrating a configuration for controlling a valve in the temperature management system according to the exemplary embodiment of the present disclosure.

As illustrated, the temperature management system according to the exemplary embodiment of the present disclosure includes a radiator 2 which emits/dissipates heat generated by the fuel cell stack 1 (i.e., during power generation) to the outside, a cooling water circulating line 3 which is connected between the fuel cell stack 1 and the radiator 2 that circulates the cooling water therebetween, a bypass line 4 and a 3-way valve 5 which selectively bypass the cooling water to prevent the cooling water from passing through the radiator 2, a water pump 6 which circulates the cooling water, and a heater 7 which increases the temperature of the cooling water.

In this configuration, an ion filter 9 is disposed in a branch line 8 which is branched from the cooling water circulating line 3. In addition, the temperature management system according to the exemplary embodiment of the present disclosure is configured to further include a flow control valve 31 which selectively interrupts a flow of the cooling water through the branch line 8 and the ion filter 9.

The flow control valve 31 may be an electronic control valve which is operated depending on a control signal of a controller, that is, a fuel cell control unit (FCU) 20 to open and close a channel of the branch line 8 in which the ion filter 9 is disposed and may be configured to control the flow into the ion filter so that flow may be interrupted during an interruption operation.

In the temperature management system according to the exemplary embodiment of the present disclosure, the fuel cell control unit 20 controls an operation of the flow control valve 31 depending on cooling water state information, in which the cooling water state information is acquired by a state detector. In particular, the temperature management system according to the exemplary embodiment of the present disclosure may include an electric conductivity sensor 11 which detects electric conductivity of the cooling water as the state detector to acquire the cooling water state information. To do so, a detection value from the electric conductivity sensor 11 is input to the fuel cell controller 20.

In the fuel cell system, an outlet position of the fuel cell stack, that is, a cooling water outlet manifold of the fuel cell stack 1 is equipped with an electric conductivity sensor, which may be, for example, safety sensors, and therefore a previously equipped electric conductivity sensor 11 without adding a separate sensor may be used.

As illustrated in FIG. 4, the fuel cell controller 20 receives the signal of the electric conductivity sensor 11 to control an opening and closing operation of the flow control valve 31 depending on electrical conductivity of the cooling water detected by the electric conductivity sensor. In this case, the fuel cell controller 20 performs a control to open the flow control valve 31 under the condition in which the detected electric conductivity is equal to or more than a preset reference value and interrupts the flow control valve 31 under the condition in which the electric conductivity is under the reference value. That is, when electrical conductivity of the cooling water reaches the reference value and thus is in a high state, the fuel cell controller 20 opens the flow control valve 31 to allow the cooling water to pass through the ion filter 9, thereby lowering electric conductivity of the cooling water.

On the other hand, when electric conductivity is below the reference value and thus is in a low state, ion removal is unnecessary, and therefore the fuel cell control unit 20 closes he flow control valve 31 to prevent the cooling water from flowing in the branch line 8 and the ion filter 9.

In the temperature management system according to the exemplary embodiment of the present disclosure, the fuel cell control unit 20 controls the cooling water to selectively allow cooling water to pass through the ion filter 9 depending on electric conductivity of the cooling water detected by the sensor 11 in real time, and in particular, interrupts the channel of the branch line 8 to prevent the cooling water from passing through the ion filter 9 when electrical conductivity is low and thus ion removal is unnecessary even though the entire amount of cooling water is circulated only between the fuel cell stack 1 and the radiator 2. The temperature management system according to the related art has a structure in which the cooling water path (branch line path) which passes through the ion filter is always opened, and therefore allows a part of the entire amount of cooling water circulating between the fuel cell stack and the radiator to circulate while still allowing some of the cooling water to pass through the ion filter at all times.

Consequently, according to the related art, the ion filter is always used (the high temperature cooling water passes through the ion filter at all times) even u when filtering is unnecessary (i.e., when electrical conductivity is less than the reference value), and as a result, the service life of the ion filter may be unnecessarily shortened.

Further, when a portion of the flow is allowed to pass through the ion filter path (branch line path) at all times, a certain flow rate loss occurs in the system and as a results effects that flow rate through the radiator thus reducing the heat transfer rate of the system.

Therefore, in the exemplary embodiment of the present disclosure when electrical conductivity of the cooling water is less than the reference value, (which is verified and set by the advanced research), the fuel cell control unit 20 activates the flow control valve 31 to close off the branch line to the ion filter 9 to prevent a portion of the cooling water from traveling along the ion filter path, thereby preventing the flow rate loss to the radiator 2 and the reduction in heat radiating amount in the radiator 2.

Consequently, according to the temperature management system according to the above-mentioned exemplary embodiment of the present disclosure, it is possible to improve the durability of the ion filter and extend the lifespan of the ion filter while reducing the contact time of an ion resin within the ion filter with the high temperature cooling water. In particular, it is possible to reduce the number of times the vehicle enters the high temperature current limiting mode which occurs when the temperature of the temperature of the cooling water is increased above a certain temperature due to the lack of the flow rate of the cooling water and the heat radiating amount in the radiator 2 (e.g., in warm weather).

Further, the heat radiating performance of the fuel cell vehicle may be improved by controlling the cooling water of the ion filter path, and therefore the current limiting time delay of arrival and the limiting time may be reduced, thereby contributing to the improvement in the performance and quality of the vehicle.

Further, the flow rate of the cooling water flowing in the radiator 2 may be increased under the condition in which electrical conductivity is not high, and therefore the driving force loss of the water pump, that is, power loss and energy loss due to the driving of the water pump 6 may be reduced, thereby contributing to the improvement in fuel efficiency of the fuel cell vehicle. That is, the operation amount of the water pump 6 may be reduced due to the increase in the flow rate to the radiator 2 and the heat radiating performance in the radiator 2 and the required cooling performance may be satisfied even at lower RPMs of the water pump 6 than the related art with the same heat radiating requirements.

Meanwhile, according to another exemplary embodiment of the present disclosure, the temperature management system may further include a temperature sensor 12 which detects the temperature of the cooling water as a state detector and the fuel cell control unit 20 may be applied with a logic/program instructions which are used to detect the temperature of the cooling water as an additional variable in order to control the opening and closing operation of the flow control valve 31.

In this configuration, the fuel cell control unit 20 controls the flow control valve 31 to allow interruption when the temperature of the cooling water detected by the temperature sensor 12 is equal to or more than a preset reference temperature. In this case, when the temperature of the cooling water reaches the reference temperature regardless of the value of electrical conductivity detected by the electrical conductivity sensor 11, the fuel cell control unit 20 closes the flow control valve 31 to increase the flow rate of the cooling water to the radiator 2.

Since a higher priority is allocated to the reduction in the number of times the vehicle enters the current limiting mode while protecting the fuel cell stack than to electrical conductivity (electrical stability), the vehicle does not directly enter the current limiting mode when the cooling water temperature reaches the reference temperature and the ion filter path of the cooling water is preferentially interrupted to first perform a process of increasing the heat transfer rate (passing the entire amount of cooling water through the radiator) and lowering the temperature of the fuel cell stack faster.

Further, the fuel cell controller 20 performs a control to interrupt the flow control valve 31 regardless of electrical conductivity of the cooling water when the temperature of the cooling water is increased and thus the number of times the vehicle enter a high temperature current limiting mode is predictable. That is, when the temperature of the cooling water reaches the reference temperature. On the other hand, in low temperatures in which the temperature of the cooling water is less than the reference temperature, the flow control valve is controlled to open and close the flow control valve 31 depending on electrical conductivity detected by the electrical conductivity sensor 11. Further, when the temperature of the cooling water reaches the temperature set to be higher than the reference temperature, that is, the current limiting mode entry setting temperature, the vehicle enters the current limiting mode similar to the related art.

Although the exemplary embodiment allocating priority to the reduction in the current limiting frequency rather than to electrical conductivity is described, the priority may also be allocated in reverse. That is, when the temperature of the cooling water reaches the current limiting mode entry setting temperature, the vehicle enters the current limiting mode but the priority is allocated to electrical conductivity (electrical stability) in the temperature of the cooling water prior to reaching the current limiting mode entry setting temperature. Additionally, if it is determined that the electrical conductivity is equal to or greater than the reference value, the fuel cell control unit 20 opens the flow control valve 31 even though the temperature of the cooling water has reached the reference temperature. By doing this, the cooling water passes through the ion filter and electrical conductivity of the cooling water may be lowered due to the ion filtering.

Further, when the electrical conductivity is less than the reference value, when the temperature of the cooling water reaches the reference temperature, the fuel cell control unit 20 closes the flow control valve 31 to increase the heat radiating amount to interrupt the flow of cooling water into the ion filter, thereby increasing the flow rate of the cooling water to the radiator 2.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A temperature management system of a fuel cell vehicle, comprising:
a fuel cell stack;
a radiator configured to emit heat generated from a fuel cell stack via cooling water;
a water pump configured to circulate the cooling water;
a cooling water circulating line connecting the fuel cell stack and the radiator;
an ion filter disposed in a branch line that branches from the cooling water circulating line;
a state detector configured to detect cooling water state information;
a flow control valve configured to selectively interrupt a flow of the cooling water into the ion filter; and
a controller configured to control an operation of the flow control valve depending on the cooling water state information detected by the state detector.

2. The temperature management system of claim 1, wherein the state detector includes at least one of an electrical conductivity sensor configured to detect electrical conductivity of cooling water and a temperature sensor configured to detect a temperature of the cooling water.

3. The temperature management system of claim 1, wherein the state sensor is an electrical conductivity sensor, and the controller is further configured to:
close the flow control valve to prevent the cooling water from passing through the ion filter when electrical conductivity detected by the electrical conductivity sensor is less than a reference value and
open the flow control valve to allow the cooling water to pass through the ion filter when the electrical conductivity is equal to or greater than the reference value.

4. The temperature management system of claim 1, wherein the state detector is a temperature sensor, and the controller is further configured to:
close the flow control valve to prevent the cooling water from passing through the ion filter when the temperature of the cooling water detected by the temperature sensor is equal to or greater than a reference temperature and
open the flow control valve to allow the cooling water to pass through the ion filter when the temperature of the cooling temperature is less than the reference temperature.

5. The temperature management system of claim 1, wherein the state detector includes both an electrical conductivity sensor and a temperature sensor and the controller is further configured to:
close the flow control valve to prevent the cooling water from passing through the ion filter when the temperature of the cooling water detected by the temperature sensor is equal to or greater than a reference temperature and
open and close the flow control valve depending on electrical conductivity detected by the electrical conductivity sensor when the temperature of the cooling water is less than the reference temperature.

6. The temperature management system of claim 5, wherein when the temperature of the cooling water is less than the reference temperature, the controller is further configured to:
close the flow control valve when the electrical conductivity is less than the reference valve and
open the flow control valve to allow the cooling water to pass through the ion filter when electrical conductivity is equal to or greater than the reference value.

7. The temperature management system of claim 1, wherein the state detector is both an electrical conductivity sensor and a temperature sensor and the controller further configured to:
open the flow control valve to allow the cooling water to pass through the ion filter when the electrical conductivity detected by the electrical conductivity sensor is equal to or greater than a reference value and
open and close the flow control valve depending on the temperature of the cooling water detected by the temperature sensor when the electrical conductivity is less than the reference value.

8. The temperature management system of claim 7, wherein when electrical conductivity is less than the reference value, the controller is further configured to:
close the flow control valve to prevent the cooling water from passing through the ion filter when the temperature of the cooling water is equal to or greater than the reference temperature and
open the flow control valve when the temperature of the cooling temperature is less than the reference temperature.

9. The temperature management system of claim 1, wherein the flow control valve is before the ion filter in the branch line.

10. A temperature management method of a fuel cell vehicle, comprising:
detecting, by a state detector, cooling water state information while the cooling water is being circulated within a cooling water circulating line between a fuel cell stack and a radiator by a water pump; and
controlling, by a controller, an operation of a flow control valve depending on the cooling water state information detected by the state detector,
wherein the flow control valve is configured to selectively interrupt a flow of the cooling water into an ion filter.

11. The temperature management method of claim 10, wherein the state detector includes at least one of an electrical conductivity sensor configured to detect electrical conductivity of cooling water and a temperature sensor configured to detect a temperature of the cooling water.

12. The temperature management method of claim 10, wherein the state detector is an electrical conductivity sensor and the method further includes
interrupting, by the flow control valve, the flow of cooling water to the ion filter to prevent the cooling water from passing through the ion filter when electrical conductivity detected by the electrical conductivity sensor is less than a reference value and
opening the flow control valve to allow the cooling water to pass through the ion filter when electrical conductivity is equal to or more than the reference value.

13. The temperature management method of claim 10, wherein the state detector is a temperature sensor and the method further includes:
interrupting flow of the cooling water to the ion filter to prevent the cooling water from passing through the ion filter when the temperature of the cooling water detected by the temperature sensor is equal to or greater than a reference temperature and
opening the flow control valve to allow the cooling water to pass through the ion filter when the temperature of the cooling temperature is less than the reference temperature.

14. The temperature management method of claim 10, wherein the state detector is both an electrical conductivity sensor and an temperature sensor, and the method further include:
closing the flow control valve to prevent the cooling water from passing through the ion filter when the temperature of the cooling water detected by the temperature sensor is equal to or greater than a reference temperature and
opening and closing the flow control valve depending on electrical conductivity detected by the electrical conductivity sensor when temperature of the cooling water is less than the reference temperature.

15. The temperature management method of claim 14, wherein when the temperature of the cooling water is less than the reference temperature, to the method further includes:
closing the flow control valve when electrical conductivity is less than the reference valve and
open the flow control valve so as to pass the cooling water through the ion filter when electrical conductivity is equal to or more than the reference value.

16. The temperature management method of claim 10, wherein the state detector is both an electrical conductivity sensor and a temperature sensor and the method further includes:
opening the flow control valve to pass the cooling water through the ion filter when electrical conductivity detected by the electrical conductivity sensor is equal to or more than the predetermined reference value and
opening and closing the flow control valve depending on the temperature of the cooling water detected by the temperature sensor under the condition in which electrical conductivity is less than the reference value.

17. The temperature management method of claim 16, wherein when the electrical conductivity is less than the reference value, to the method further includes:
closing the flow control valve to prevent the cooling water from passing through the ion filter when the temperature of the cooling water is equal to or greater than the predetermined reference temperature and
opening the flow control valve when the temperature of the cooling temperature is less than the reference temperature.

18. A non-transitory computer readable medium containing program instructions executed by a controller, the computer readable medium comprising:
program instructions that interpolate cooling water state information from a state detector while the cooling water is being circulated within a cooling water circulating line between a fuel cell stack and a radiator by a water pump; and
program instructions that control an operation of a flow control valve depending on the cooling water state information detected by the state detector,
wherein the flow control valve is configured to selectively interrupt a flow of the cooling water into an ion filter depending on the cooling water state information.
